(19) United States
(12) Patent Application Publication
(10) Pub. No.: US 2025/0292067 A1
(43) Pub. Date: Sep. 18, 2025

(54) AI ENTITY AND MESSAGE RESOLUTION

(71) Applicant: LEDGERDOMAIN INC., Las Vegas, NV (US)

(72) Inventors: William JACK, Boston, MA (US); Alex COLGAN, Yarmouth (CA); Benjamin James TAYLOR, Las Vegas, NV (US)

(73) Assignee: LEDGERDOMAIN INC., Las Vegas, NV (US)

(21) Appl. No.: 19/078,163

(22) Filed: Mar. 12, 2025

Related U.S. Application Data
(60) Provisional application No. 63/564,479, filed on Mar. 12, 2024.

(51) Int. Cl. G06N 3/045; H04L 9/40

(52) U.S. Cl. CPC G06N 3/045; H04L 63/0421

(57) ABSTRACT

The technology disclosed relates to Artificial Intelligence techniques for sharing and managing information across organizational boundaries. Specific embodiments of the technology disclosed include the integration of LLM/LMM-based information comparison to enable alignment on a ground truth (or an agreed upon data standard) across multiple documents related to a community's data, and communicating that alignment to the users in the community. As a result, the users can update data and make amendments to documents affecting related actions among multiple community members. in order to resolve any misalignment between data and physical reality. Information exchange can be securable through verifiable credential technology.

### PRIORITY

This application claims priority to and the benefit of U.S. Provisional Patent Application No. 63/564,479, titled, “AI FOR ENTITY AND MESSAGE RESOLUTION” filed on 12 Mar. 2024 (Atty. Docket No. LEDG-1014-1), which priority application is hereby incorporated by reference herein in its entirety for all purposes.

### INCORPORATIONS

The following materials are incorporated by reference for all purposes as if fully set forth herein:
U.S. Pat. No. 11,848,754 (Attorney Docket Number LEDG 1008-1);
U.S. Pat. No. 11,741,215 (Attorney Docket Number LEDG 1009-1);
U.S. Pat. No. 11,736,290 (Attorney Docket Number LEDG 1010-1);
U.S. Pat. No. 11,741,216 (Attorney Docket Number LEDG 1011-1);
U.S. patent application Ser. No. 18/234,293 (Attorney Docket Number LEDG 1012-2); and
Verifiable Credentials Data Model v2.0 9 Mar. 2024 (//www.w3.org/TR/vc-data-model-2.0/).

### INCORPORATION BY REFERENCE OF FILE SUBMITTED ELECTRONICALLY WITH APPLICATION

The following file in ASCII text format is submitted with this application as Appendix A and is incorporated by reference.

| File name | Creation date | Size |
|---|---|---|
| Mount_Olympus_EPCIS.txt | Mar. 5, 2024 | 19.4 KB. |

### FIELD OF THE TECHNOLOGY DISCLOSED

The technology disclosed relates to identification of future activity options. In particular, it relates to artificial intelligence (AI) based techniques for identifying and resolving data discrepancies in data of varying formats shared or sharable among a widely varying array of actors. The technology disclosed also relates preserving privacy for certain types of data identified in data that is otherwise to be shared.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Artificial Intelligence (AI) techniques have demonstrated great promise in addressing a variety of problems in a wide array of applications. While industries have developed procedures for addressing problems in working with data across platforms, often, these procedures are heavily labor intensive or difficult to fully address. Many areas of incompatible systems and approaches remain. There are abundant sources of information underpinning a wide variety of types of transactional processes, developed by different actors and having different data organizations and/or data models. Further, many of the interfaces are also platform specific, may be cumbersome to use, and require considerable study to master.

An opportunity arises to develop better machine learning and other Artificial Intelligence techniques for sharing and managing information across organizational boundaries. Better, more robust, more resilient and transparent user experiences and systems may result.

### SUMMARY

The technology disclosed relates to Artificial Intelligence techniques for sharing and managing information across organizational boundaries. Specific embodiments of the technology disclosed include the integration of LLM/LMM-based information comparison to enable alignment on a ground truth (or an agreed upon data standard) across multiple documents related to a community's data, and communicating that alignment to the users in the community. As a result, the users can update data and make amendments to documents affecting related actions among multiple community members. in order to resolve any misalignment between data and physical reality. Information exchange can be securable through verifiable credential technology.

Specific embodiments of the technology disclosed can provide a groundbreaking utility designed to revolutionize the way documents are managed, such as the data managed by the ˜800,000 participants within the pharmaceutical supply chain, or cross-border trade agreement and tariff tracking applications, or multiple platform, multiple actor manufacturing, warehousing, or merchandising infrastructures and other implementations. Certain embodiments can provide solutions capable of one or more of: leverage secured decentralized channels for authentication and authorization, enable the resolution between disparate documents according to both known and emerging schemas, employ machine learning techniques to automatically identify, match, and reconcile documents, and enable users to securely align on ground truth.

Particular aspects of the technology disclosed are described in the claims, specification and drawings.

### BRIEF DESCRIPTION OF THE DRAWINGS

FIG. 1 illustrates an architectural level schematic of a system for automatically identifying and resolving data discrepancies in a transactional document or series of transactional documents, in an example of the technology disclosed.

FIG. 2 illustrates an architectural level schematic of an example resolver.

FIG. 3A illustrates an example workflow using resolver of FIG. 2.

FIG. 3B illustrates an alternative workflow according to another implementation which enables human-initiated requests for information and error reports.

FIG. 3C illustrates an example flow chart of a misalignment exceptions process enabled by the disclosed utility, according to one implementation.

FIG. 4 shows an exemplary implementation of a supply chain document workflow in an example implementation in the context of supply chain automation.

FIG. 5 shows an upload box, within a graphical user interface enabling a user to upload a file for data analysis.

FIG. 6 shows a list of uploaded documents, within a graphical user interface, such as a packing slip or an EPCIS data file.

FIG. 7 shows a JSON viewer, within a graphical user interface displayed to the user via the resolver dashboard that provides improves accessibility for viewing and manipulating using JavaScript Object Notation (JSON) data.

FIG. 8 shows an example of a packing list form that can be uploaded via the user dashboard for processing.

FIGS. 9A, 9B and 9C illustrate a high-level processing workflow including data identification and processing by an LLM/LMM applied to the example document of FIG. 8, in which FIG. 9A shows an example resolver that detects that the example input document is of a document type Packing Slip, FIG. 9B shows an example resolver analyzing the packaging slip using an LLM/LMM model to find unit detail data, and FIG. 9C shows example resolver locating significant data in the unit detail data.

FIG. 10, which shows a representative structured data output of an example resolver.

FIG. 11 illustrates a deep learning system in a supervised or semi-supervised implementation.

FIG. 12 is a simplified block diagram of a computer system that can be used for identifying mismatches and other exceptions in data of varying formats being shared across platforms and organizations that provides a resolution of such exceptions identified, within accordance with an implementation of the disclosed technology.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows. Described are novel artificial intelligence based techniques for addressing entity and message resolution among various actors and actors' documents in a computer implemented workflow or complex collections of computer implemented workflows.

Computer implemented workflows, such as manufacturing processes, “order-to-cash” processes, or supply chain logistics, often rely on the ability to seamlessly integrate, manage, and reconcile disparate documents and data formats across various stages. This challenge is compounded by a wide range of factors. Different entities including manufacturers, distributors, retailers, providers, and regulatory jurisdictions use a diverse range of document formats, standards, and protocols used across different entities. Data misalignments can occur due to various computer and human errors, resulting in the virtual supply chain no longer reflecting the reality of the physical supply chain. Workflows are often multidirectional, including chained document exchanges between trading partners (e.g., purchase order forms, advanced shipping notifications, EPCIS, packing slips, invoices, etc.) that must broadly describe a shared reality. The rise of personalized manufacturing and shipping adds an additional layer of complexity. For example, personalized manufacturing and shipping in the healthcare space alone encompasses biologics, cell and gene therapists, orphan drugs, and so on, each with their own associated special handling requirements, complex manufacturing processes, and matching with a small (or even singular) patient complication. Moreover, newly emerging schemas and the continuous evolution of data exchange standards result in a constantly moving target.

Traditionally, transcription between systems occurred by a route that can be categorized in practical terms as being manual (e.g., fax or file sharing services) or in reliance on purpose-built machine-to-machine communication via so-called middleware APIs, microservices, or similar. Effectively manual transcription is error-prone, insecure, and lacks sense of state. While modern middleware solutions have enables businesses to more easily connect applications, data, and/or devices across on-premises and cloud environments thanks to API-led connectivity and utilization of analytical models and machine learning to support real-time decision-making.

Error identification and reconciliation between enterprises, however, represents an additional set of challenges. Legacy systems are typically unable to accept and track revisions to shared data across documents over time, effectively “freezing” the documents and requiring manual workarounds to accept updated versions. Differing enterprises and solution providers often use non-standardized internal and external identifiers. Authentication processes for external counterparties to ensure that data reconciliation efforts are being undertaken securely and with appropriate permissions are complex to implement, but such processes represent one of many actions necessary to secure private or sensitive data, like PII, that must be identified and handled appropriately, e.g., by stripping out or otherwise anonymizing the data. Another source of complication is the centralization of multiple entities (e.g., “multi-tenant” entities, “EPCIS pools”) into a single instance, thereby introducing privacy risk and overhead associated with querying data or the inclusion of private or sensitive data.

### Overview the Technology

Specific embodiments of the technology disclosed include the integration of LLM/LMM-based information comparison to enable alignment on a single ground truth (or an agreed upon data standard) across multiple documents related to a community's data, such as a supply chain, and communicating that alignment to the users in the community. As a result, the users can update data and make shipments, returns, credits, and debits in order to resolve any misalignment between data and physical reality of the supply chain. The information exchange is securable through verifiable credential technology.

Past solutions have relied either on rules-engine or human comparison across documents-limiting the scope of documents they could compare, the accuracy with which comparison could be carried out, and the speed at which the comparison, alignment on a resolution, and resolution could be done.

Some embodiments of the technology disclosed offer an LLM/LMM-based solution that is more flexible to various data formats. In contrast to other LLM/LMM-based approaches that can be easily manipulated through prompt engineering, an embodiment of the disclosed solution more effectively mitigates the privacy/security impact of such attacks by scoping the task of the LLM/LMM to the extraction and comparison of data across files, rather than generating de novo outputs that are vulnerable to third party bad actors. Further embodiments of the technology disclosed provides an innovative approach for enabling multiple users to exchange data with each other in a secure, ad-hoc manner through the use of verifiable credentials.

### Related Technologies & Keywords

Some approaches include performing SQL joins upon normalized databases, which requires data that has been normalized and well-structured. However, real-world applications typically involve a large volume of unstructured data, constant changes in data format between and within suppliers, master data challenges, and differing interpretations of electronic product code information services (EPCIS) data. The technology disclosed, in contrast, is capable of performing more nuanced inferences to support data matching, including tasks like automatic exception identification and resolution on structured and/or unstructured data. High-accuracy, high-efficiency models like the technology disclosed can be more cost effective for customers (e.g., supply chain vendors and groups of enterprises struggling to align on a common data standard that is applicable to newly generated data as well as historical data sets and unstructured data) by reducing overages/underages and reducing regulatory burden.

W3C-compliant verifiable credentials have proven to be a versatile solution to the challenge of building a secure B2B community with mutually authenticated connections, including providing a ready means for authenticated messages between enterprises, like the sharing of “know your customer/know your supplier” (KYC/KYS) and licensure data required in industries such banking and financial services, real estate, legal services, healthcare, and telecommunications.

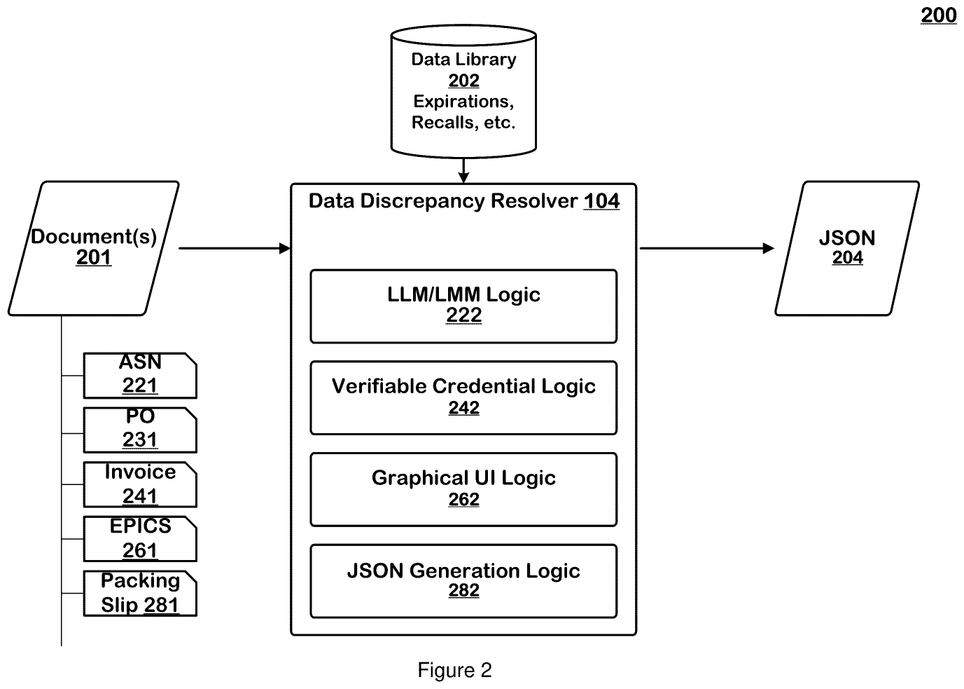

A particular component within the disclosed data discrepancy resolver model may comprise a variety of system components and configurations. The components, as introduced later within FIG. 2, may be configured as an algorithm process, statistical analysis, a factory method, a decision tree or flow chart, an automation protocol, a machine learning model such as logistic regression or random forest, a deep learning model such as a convolutional neural network, a recurrent neural network, and/or a multi-task neural network. In some embodiments, at least two components within the disclosed data discrepancy resolver model may be configured to comprise an overlapping model/statistical analysis or a hyperparameter. In other embodiments, no components within the disclosed data discrepancy resolver model may be configured to comprise an overlapping model/statistical analysis or a hyperparameter.

A variety of statistical models and machine learning analyses can be implemented for each respective model component to generate an output “ground truth” describing a transactional event or series of such events. A summary of relevant machine learning models will be described prior to introduction of various model architectures comprising these models.

A data discrepancy resolver may comprise a plurality of machine learning models, examples of which will now be discussed in further detail. A machine learning model can take as input one or more types of transaction related documents, or output data generated by a language understanding model in a pre-processing step, as input features, in order to generate a using JavaScript Object Notation (JSON) or other format document describing the details of the transaction or transactions being made. A central issue is that classification performance depends heavily on the quality and the relevance of these features. For example, incomplete representation of the data may reduce classification accuracy.

Deep learning, a subdiscipline of machine learning, addresses this issue by embedding the computation of features into the machine learning model itself to yield end-to-end models. This outcome has been realized through the development of deep neural networks, machine learning models that comprise successive elementary operations, which compute increasingly more complex features by taking the results of preceding operations as input. Deep neural networks are able to improve prediction accuracy by discovering relevant features of high complexity, such as concordance among statements or accuracy of statements within the document or collection of documents related to a particular transaction or group of transactions. The construction and training of deep neural networks have been enabled by the explosion of data, algorithmic advances, and substantial increases in computational capacity, particularly through the use of graphical processing units (GPUs).

An example of a deep learning problem is one that predicts whether a specific symbol is an appropriate selection as a graphical element given features of at least one textual element identified within the subject documents such as a particular product's trade name, a particular product's classification according to a governmental body or trade association, or a particular limitation(s) (e.g., quantity, dosage, size, weight, purity, or the like) within the document. Training a machine learning model refers to learning its parameters, which commonly involves minimizing a loss function on training data with the aim of making accurate predictions on unseen data.

For many deep learning problems, the input data can be represented as a table with multiple columns, or features, each of which contains numerical or categorical data that are potentially useful for making predictions. Some input data are naturally represented as features in a table (such as temporal data), whereas other input data need to be first transformed (such as categorization of textual elements into a particular linguistic category) using a process called feature extraction to fit a tabular representation. Tabular data are standard for a wide range of supervised machine learning models, ranging from simple linear models, such as logistic regression, to more flexible nonlinear models, such as neural networks and many others.

Logistic regression is a binary classifier, that is, a supervised learning model that predicts a binary target variable. Logistic regression predicts the probability of the positive class by computing a weighted sum of the input features mapped to the [0, 1] interval using the sigmoid function, a type of activation function. The parameters of logistic regression, or other linear classifiers that use different activation functions, are the weights in the weighted sum. Linear classifiers fail when the classes cannot be well discriminated with a weighted sum of input features. To improve predictive performance, new input features can be manually added by transforming or combining existing features in new ways, for example, by taking powers or pairwise products.

Neural networks use hidden layers to learn these nonlinear feature transformations automatically. Each hidden layer can be thought of as multiple linear models with their output transformed by a nonlinear activation function, such as the sigmoid function or the more popular rectified-linear unit (ReLU). Together, these layers compose the input features into relevant complex patterns, which facilitates the task of distinguishing two classes.

Deep neural networks use many hidden layers, and a layer is said to be fully-connected when each neuron receives inputs from the neurons of the preceding layer. Neural networks are commonly trained using stochastic gradient descent, an algorithm suited to training models on very large data sets. Embodiment of neural networks using modern deep learning frameworks enables rapid prototyping with different architectures and data sets.

Intra as well as inter document dependencies in data both within document as well as across documents related to a transaction when considered provide for effective predictions. For example, shuffling a plurality of particular products in a series of orders that does not correspond with the linear time progression of a transaction can severely disrupts informative patterns. These data dependencies set transactional data apart from tabular data, for which the ordering of the features is arbitrary. Consider the problem of generating a ground truth transactional document as comprising a timeline that illustrates the progression of a set of transactional elements (e.g., spec., order, ship, etc.) over time.

A convolutional layer is a special form of filter or fully-connected layer in which the same fully-connected layer is applied locally, for example, in a 60 minute window, to all transcript positions. Each convolutional layer scans the transcript with several filters by producing a scalar value at every position, which quantifies the match between the filter and the sequence. As in fully-connected neural networks, a nonlinear activation function (commonly ReLU) is applied at each layer. Next, a pooling operation is applied, which aggregates the activations in contiguous bins across the positional axis, commonly taking the maximal or average activation for each channel. Pooling reduces the effective sequence length and coarsens the signal. The subsequent convolutional layer composes the output of the previous layer. Finally, the output of the convolutional layers can be used as input to a fully-connected neural network to perform the final prediction task. Hence, different types of neural network layers (e.g., fully-connected layers and convolutional layers) can be combined within a single neural network.

Different types of neural network can be characterized by their parameter-sharing schemes. For example, fully-connected layers have no parameter sharing, whereas convolutional layers impose translational invariance by applying the same filters at every position of their input. Recurrent neural networks (RNNs) are an alternative to convolutional neural networks for processing sequential data, such as time series, that implement a different parameter-sharing scheme. Recurrent neural networks apply the same operation to each transcript element. The operation takes as input the memory of the previous transcript element and the new input. It updates the memory and optionally emits an output, which is either passed on to subsequent layers or is directly used as model predictions. By applying the same model at each transcript element, recurrent neural networks are invariant to the position index in the processed transcript.

The main advantage of recurrent neural networks over convolutional neural networks is that they are, in theory, able to carry over information through infinitely long transcripts via memory. Furthermore, recurrent neural networks can naturally process sequences of widely varying length, such as a plurality of text segments of differing word or character length or a plurality of transcripts each corresponding to a meeting with differing time lengths such as fifteen minutes, sixty minutes, and eighty-five minutes. However, convolutional neural networks combined with various tricks (such as dilated convolutions) can reach comparable or even better performances than recurrent neural networks on sequence-modelling tasks, such as audio synthesis and machine translation. Moreover, because recurrent neural networks apply a sequential operation, they cannot be easily parallelized and are hence much slower to compute than convolutional neural networks.

For the language understanding and image recognition tasks involved in the disclosed technology, many embodiments employ models such as those within the transformer family like autoencoders and large language models for language understanding and natural language processing (NLP) tasks.

In many embodiments, the data discrepancy resolver comprises a transformer model that relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by the other inputs' representations, this results in an effectively global receptive field across the whole input sequence. This stands in contrast to, e.g., convolutional architectures which typically only have a limited receptive field. Some of the state-of-the-art models use Transformers, a more powerful and faster model than neural networks alone. Neural networks process input in series (e.g., time series data including sequencing-by-synthesis (SBS) sequencing data) and weight relationships by distance in the series. Transformers can process input in parallel and do not necessarily weight by distance. Transformers can be used in addition to alternative architectures of neural networks.

The artificial intelligence model used in the algorithmic layout method can include self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, BERT, SpanBERT, ROBERTa, XLNet, ELECTRA, UniLM, BART, T5, ERNIE (THU), KnowBERT, DeiT-Ti, DeiT-S, DeiT-B, T2T-ViT-14, T2T-VIT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, VITB/16-FRCNN, VIT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

Attention mechanisms distinguish transformers from other artificial intelligence and machine learning models. The attention mechanism provides a solution for the so-called vanishing gradient problem. At every step of one example attention mechanism that can be implemented within certain embodiments of the technology disclosed, a decoder is given an attention score, e, for each encoder hidden state. In other words, the decoder is given weights for each relationship between words in a sentence. The decoder uses the attention score concatenated with the context vector during decoding. The output of the decoder at time step t is be based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

A user skilled in the art will recognize that many variations of the above-described artificial intelligence technology exist and the disclosed language understanding tasks herein may comprise a range of algorithm and artificial intelligence model architecture and ensemble structure without deviating from the scope or spirit of the technology.

Now, the discussion turns to a description of the disclosed data discrepancy identification and resolution system and methods in further detail.

### System Overview

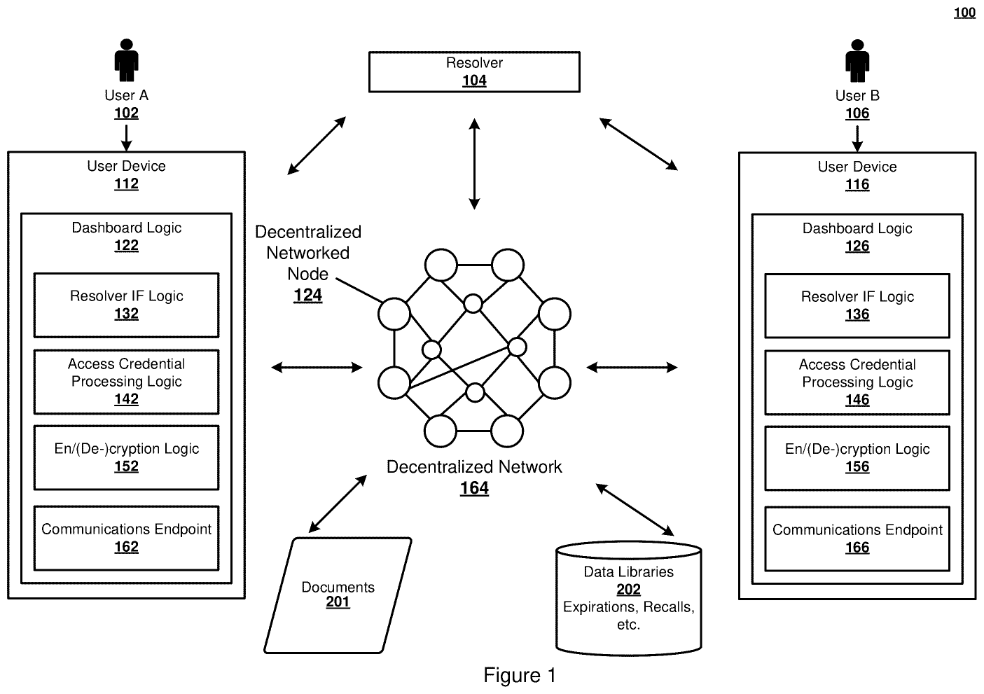

FIG. 1 illustrates an architectural level schematic of a system for automatically identifying and resolving data discrepancies in a transactional document or series of transactional documents, in an example of the technology disclosed. Because FIG. 1 is an architectural diagram, certain details are intentionally omitted to improve the clarity of the description. The discussion of FIG. 1 is organized as follows. First, the elements of the figure are described, followed by their interconnections. Then, the use of the elements in the system is described in greater detail.

System 100 broadly speaking supports coordinating efforts of a (potentially large) plurality of actors exchanging documents of various kinds via devices in a decentralized network.

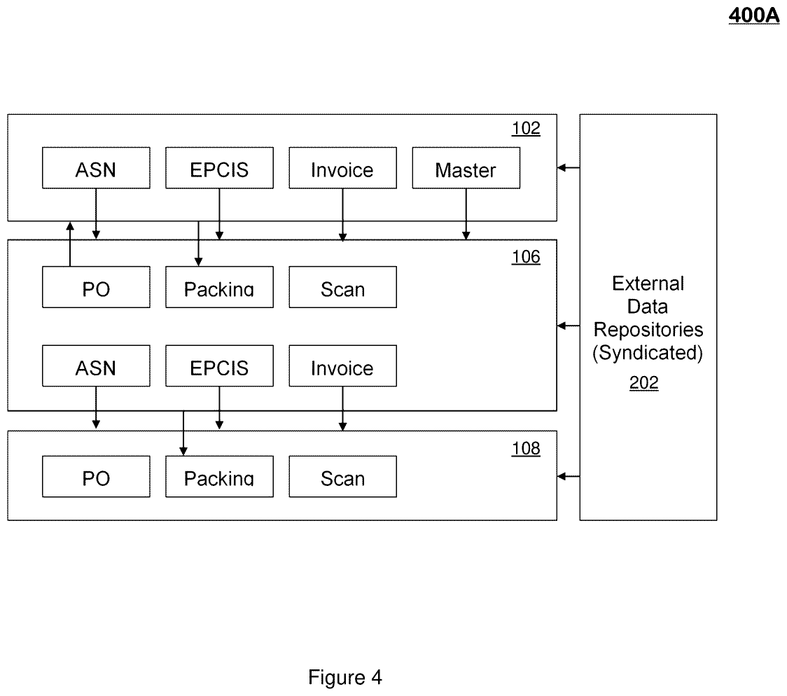

In one implementation, as shown in FIG. 1, system 100 enables plurality of actors including User A 102, and User B 106 to act in concert via decentralized network 164 interconnecting them with a potentially large number of other actors, not shown in FIG. 1 for simplicity's sake, a novel technological resolver 104 that enables resolution of data mismatches among documents 201 exchanged by participants of the network 164. Documents 201 in a commercial supply chain context can include a variety of file formats, as shown in FIG. 4, such as EPCIS data, advanced shipping notices (ASN), purchase order (PO) forms, packing slips, and data related to recalls, shortages, or extended expiration dates, accessible by a network server such as a cloud and/or decentralized server. Data from such forms is made accessible to users 102, 106 by user devices 112, 116 via a dashboard 122, 126 (i.e., user interface) with aligned data matches between the various formats in the data to identify product data such as overages, underages, potentially mismatched data, and other forms of exceptions and/or errors as determined by resolver 104 and made available to user devices 112, 116 via resolver IF logic 132, 136. Aligned data can be shared between trusted users A, B for viewing and manipulation in a .JSON format via communications endpoints 162, 166. Encryption/decryption logic 152, 156 and access credential processing logic 142, 146 maintain trust among users in the decentralized network 164.

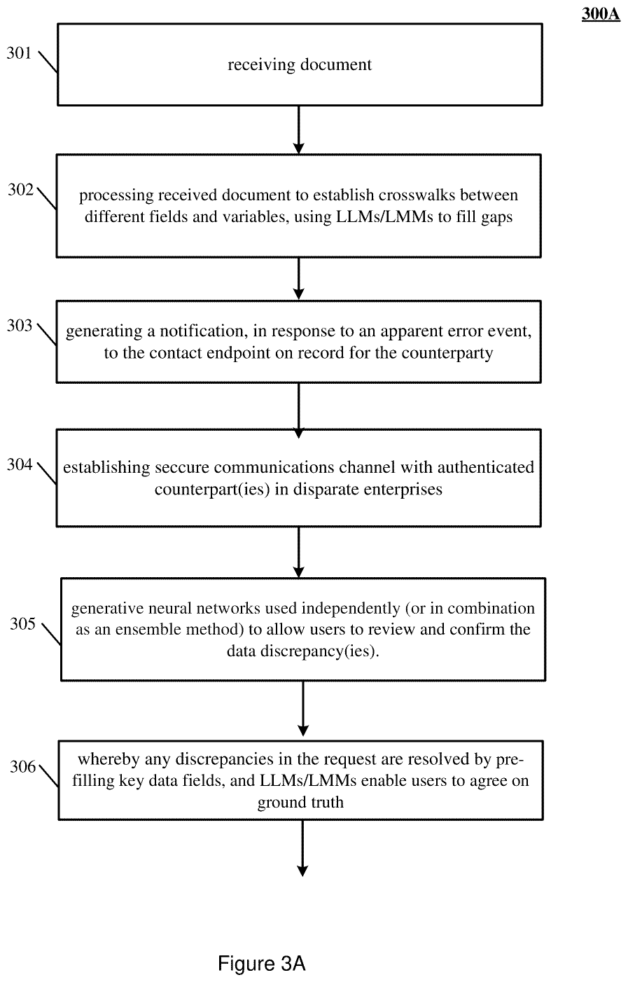

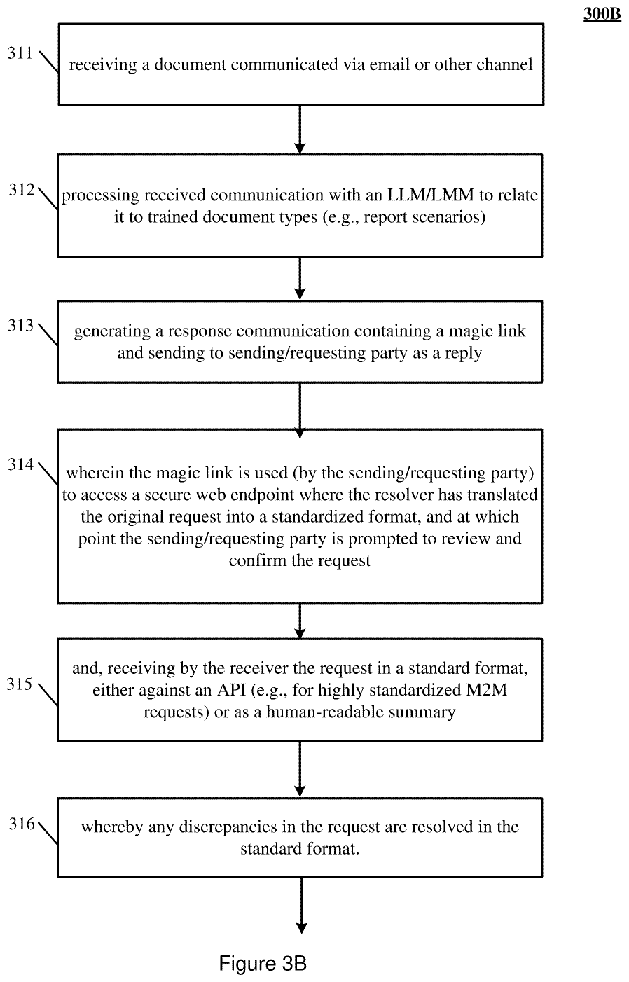

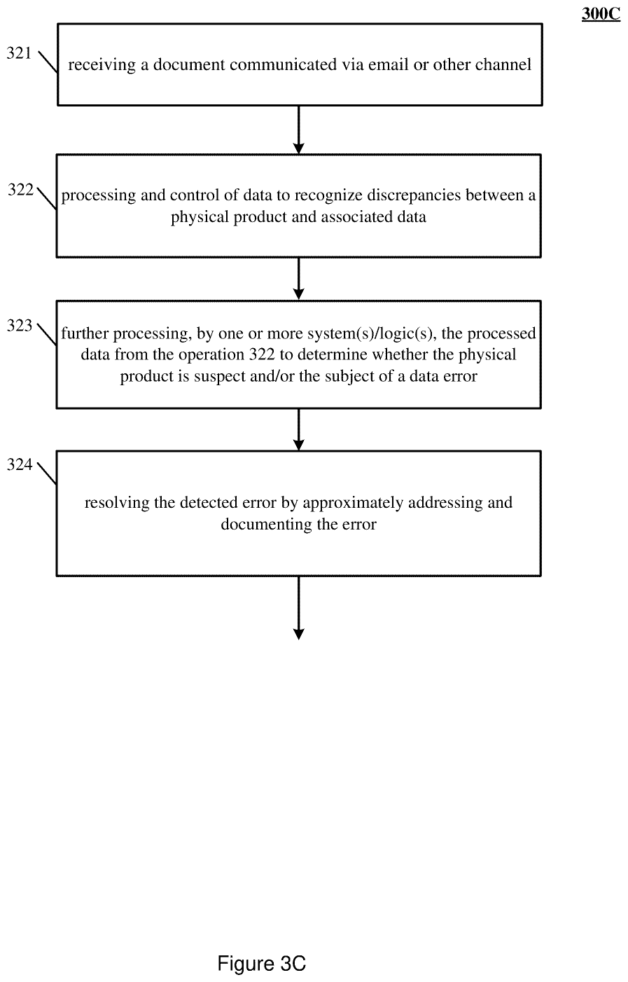

Now with reference to FIG. 2, and flowchart 300A of FIG. 3A, an example resolver is described. Various implementations of the resolver 104 include the following operations in relation to the above-mentioned system functionalities. In an action 301, the data discrepancy resolver 104 ingests a wide range of files and formats, including unstructured and/or physical documents, e.g., ASN 221, PO 231, Invoice 241, EPICS 261, Packaging Slip 281 and others. In an action 302, the received document is processed to establish crosswalks between different fields and variables. Large language models (LLM) or large multimodal models (LMMs) 222 are employed to fill gaps where preconfigured crosswalks have not yet been established. LLMs are configured to process and/or generate textual data and are thus well-suited for applications with text formats. However, for applications that may involve files that include images, audio, video, and other non-textual data, the technology disclosed can include LMMs configured to integrate and process multiple types of data inputs, or modalities. Ground truth can be expressed/shared via JSON 204 or other format documents/.

In an action 303, the technology disclosed generates a notification, in response to an apparent error event, to the contact endpoint on record for the counterparty (e.g., email address, API endpoint, DIDComm Messaging, etc.). This can include a machine-readable file that describes the exception. In action 304, secure communications are established by authenticating authorized counterparty(ies). In implementations involving email endpoints, the notification includes a magic link to a secure web endpoint where a response can be submitted. For signing and other authentication operations, the verifiable credential logic 242 leverages cryptographic materials such as W3C verifiable credentials (VCs); for authorization operations, the technology disclosed leverages organization details, localized whitelisting, and associated signatures on prior submissions for authentication operations. For example, only the upstream trading partner responsible for a shipment can attempt to send revised information related to that shipment to the downstream trading partner. With authentication and authorization in place, the technology disclosed establishes secure communication channels between disparate enterprises. For reconciliation purposes, in action 305, the technology disclosed can pre-fill key data fields and leverages artificial intelligence models such as LLMs/LMMs (e.g., of ChatGPT, LLAMA, Mistral, Textract, and other generative neural networks used independently or in combination as an ensemble method) to allow users to review and confirm the problem via graphical UI logic 262. To resolve conflicts, in action 306, the technology disclosed can pre-fill key data fields and leverages LLMs/LMMs to allow users to agree on ground truth that is shared by JSON 204 format files created by JSON generation logic 282.

FIG. 3B illustrates an alternative workflow 300B according to another implementation which enables human-initiated requests for information and error reports. In a first operation 311, an email (or other communications) sent to a dedicated support address, or via another communication channel is received. Next, in operation 312, the disclosed resolver utility ingests the email and parses it with an LLM/LMM to relate it to trained document types (e.g., report scenarios, etc.). In operation 313, a response email containing a magic link is generated, and the response email is sent to the original sender/requestor. Next, in operation 314 the magic link can be used by the original sender/requestor to access a secure web endpoint where the disclosed utility has translated the original request into a standardized format, at which point the sender is prompted to review and confirm the request. Then in operation 315, the receiver receives the request in a standard format, either against an API (e.g., for highly standardized M2M requests) or as a human-readable summary. Whereby any discrepancies in the request are resolved in the standard format.

FIG. 3C illustrates an example flow chart of a misalignment exceptions process enabled by the disclosed utility, according to one implementation. A document is received for examination in action 321. A first identification operation 322 comprises the processing and control of data to recognize discrepancies between a physical product and associated data. In a second understanding operation 323, the processed data from the first operation is further processed by one or more system(s)/logic(s) to determine whether the physical product is suspect and/or the subject of a data error. Any detected error is resolved in a third resolution operation 324 by approximately addressing and documenting the error.

Having reviewed the components underlying the technology disclosed, we turn next to an example application in the context of supply chain automation.

### Example Use Case

FIG. 4 shows an exemplary implementation of a supply chain document workflow in the context of supply chain automation. In FIG. 4 documents and interactions are shown by and between an upstream trading partner (e.g., user A 102) sending a shipment to a wholesale distributor (e.g., user B 106). The wholesale distributor, in turn, ships to a retailer/provider 108. The upstream trading partner, wholesale distributor, and retailer/provider each respectively leverage external data repositories to some extent. Verifying that information aligns properly using conventional practices involves eight manual steps, and the entities are linked to known physical addresses.

A single deviation from ground truth data between any of these documents, or between the documents and the real-world flow of product, presents a problem to key areas including identification, notification, authentication, authorization, communication, reconciliation, and resolution.

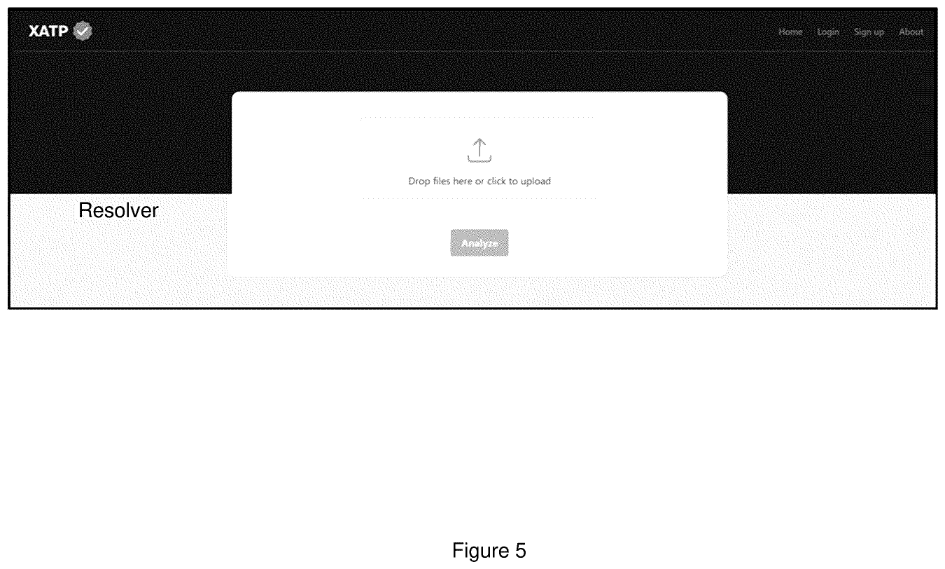

FIGS. 5-7 below show screens from an example graphical user interface (or “dashboard”) illustrating an embodiment enabling combining data in various format documents from one or more different enterprises (e.g., one or more of the data formats shown in FIG. 4), according to one implementation of the technology disclosed. FIG. 5 shows an upload box, within a graphical user interface enabling a user to upload a file for data analysis.

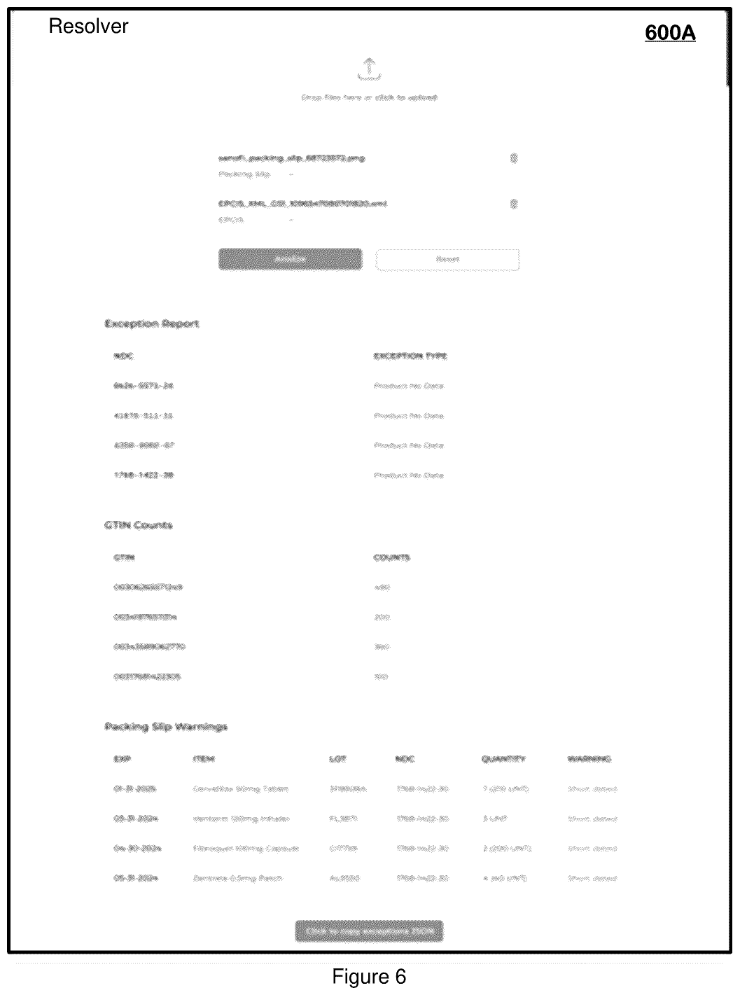

FIG. 6 shows a list of uploaded documents, within a graphical user interface, such as a packing slip or an EPCIS data file. In this example embodiment, a Resolver 104 tool (also known by tradename: “RoboResolver”) has identified a series of exception events and warnings, like short-dated products, as well as a list of identified global trade item numbers (GTIN).

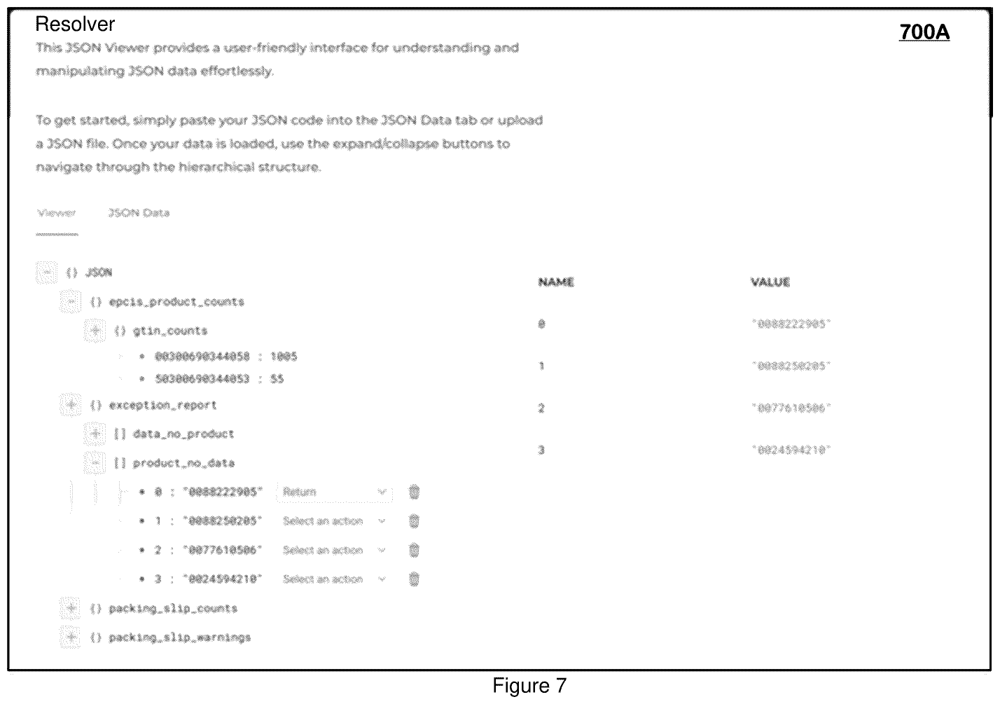

FIG. 7 shows a JSON viewer, within a graphical user interface displayed to the user via the resolver dashboard that provides improves accessibility for viewing and manipulating JSON data. In FIG. 7, the user views four identification numbers found that do not match to a product with a drop-down list of options for the user to address the potential error.

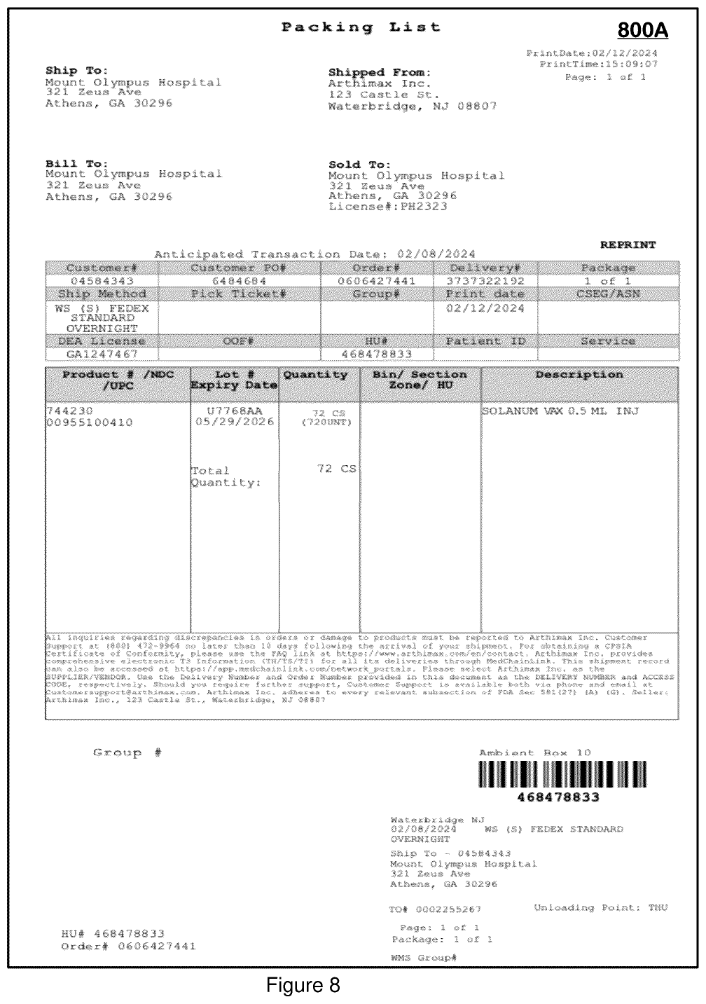

FIG. 8 shows an example of a packing list form that can be uploaded via the user dashboard for processing. The packing list includes shipping data, a PO number, and data associated with the included product such as the product name, identification number, expiration date and/or duration of useful life, and volume/quantity. The data included within the packing list form can be identified by an LLM/LMM model and matched appropriately with data in other forms, despite having a different format. Further in implementations, document contents can be matched with an inventory conducted of a shipment's contents, thereby enabling a shipment to be checked against the document. Any discrepancies can be noted to the recipient as well as the sender to update the ground truth relating to the shipment.

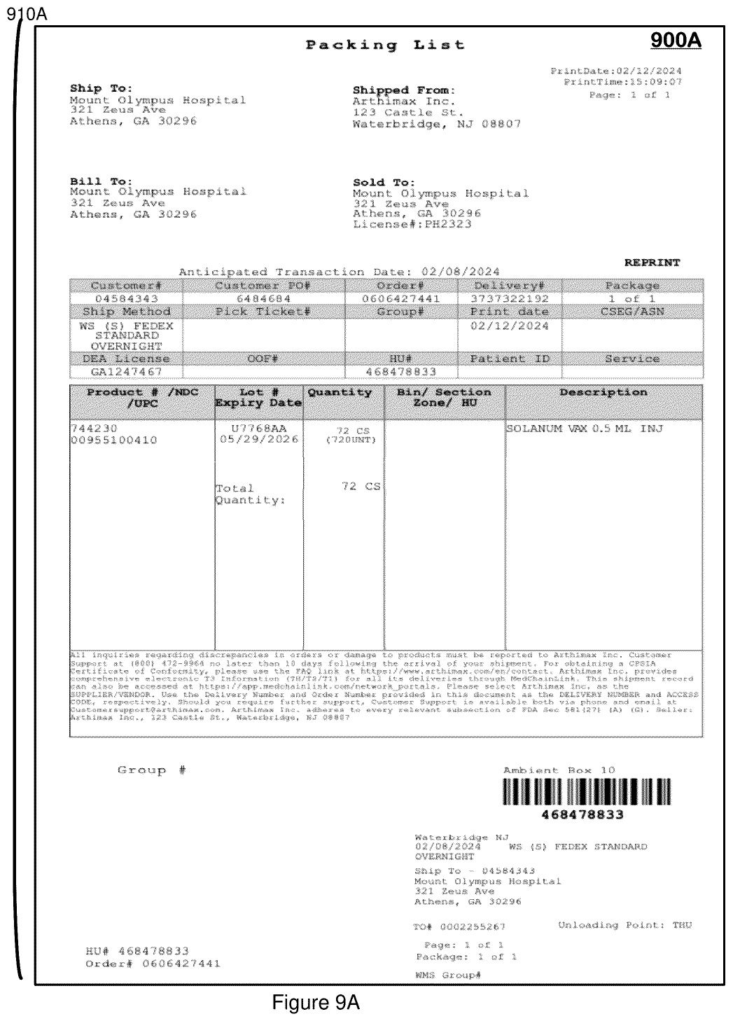

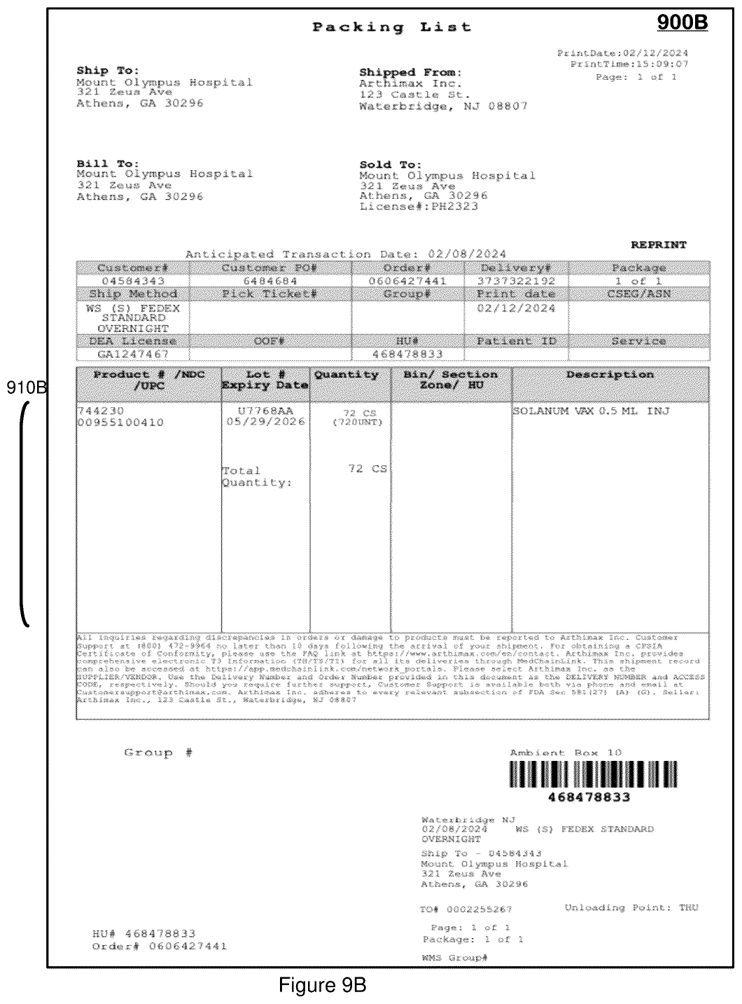

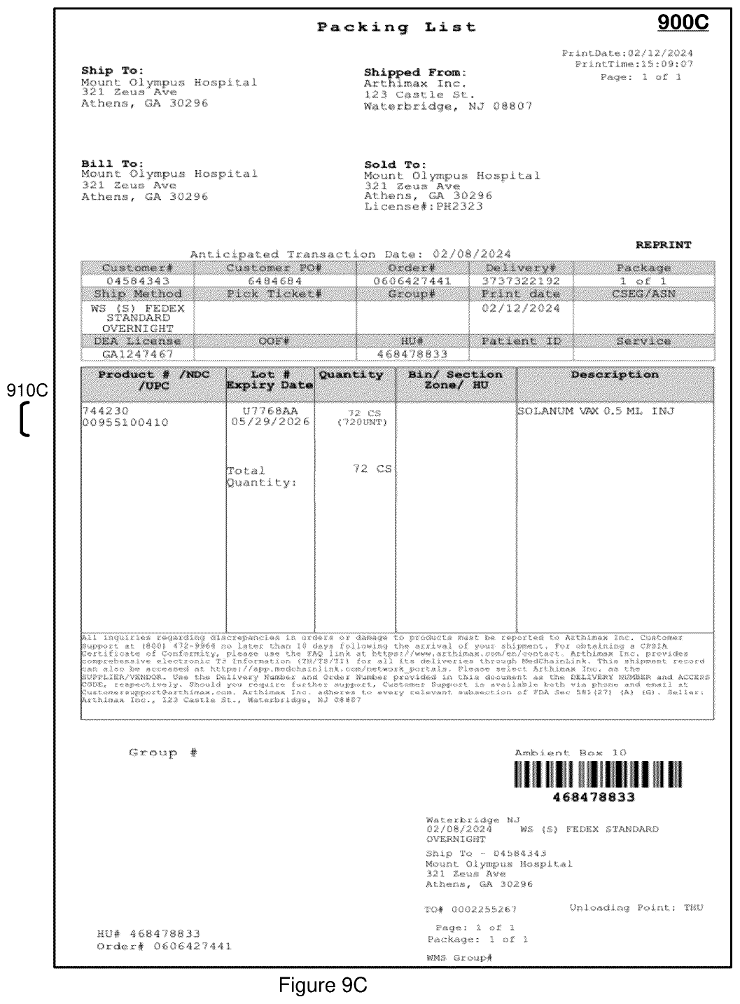

FIGS. 9A, 9B and 9C illustrate a high-level processing workflow including data identification and processing by an LLM/LMM applied to the example document of FIG. 8. FIG. 9A shows an example in which example resolver 104 detects that the example input document of FIG. 8 is of a document type 910A Packing Slip. The data included within the packing list form can be identified by an LLM/LMM model and matched appropriately with data in other forms, despite having a different format. In FIG. 9B, example resolver 104 analyzes the packaging slip using an LLM/LMM model to find unit detail data 910B. Next with reference to FIG. 9C, resolver 104 locates within the unit detail data, significant data 910C (in this case package contents and expiry information.

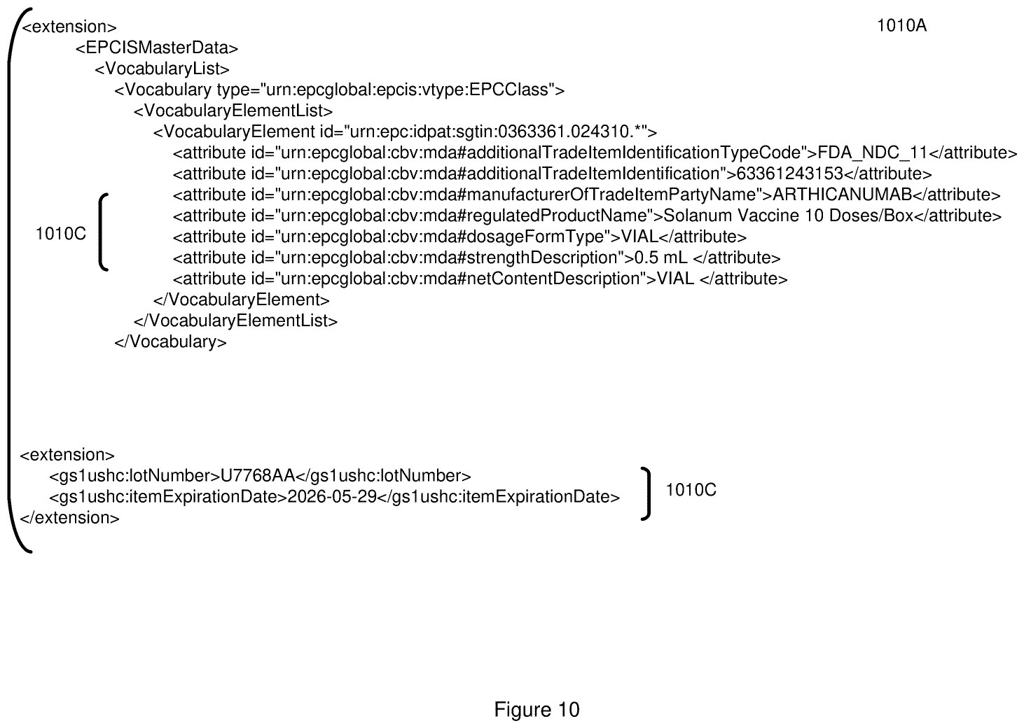

Now with reference to FIG. 10, which shows a representative structured data output of Resolver 104. The LLM/LMM model is configured to turn unstructured data from the packing slip into structured data such as a .JSON file 1010A containing the file type (packing slip) and unit details 1010C (Solanum Vaccine 0.5 ml, 10 Doses/Box, 720 count, good until May 29, 2026) determined from unstructured data 910C by resolver 104. The structured data is then hashed, signed, or attached to a verifiable credential or another ledger-based widget. The signed digital package can then be forwarded (e.g., via email, specialty rails like DIDComm messaging, or legacy rails like AS2) within the enterprise/entity or outside to a different enterprise/entity. The model can be further configured to strip out, anonymize, or block the transmission of private or otherwise sensitive data. In one implementation, a robot is further employed on the receiving end such that the mediation of messaging between entities is automated to reduce dependency on manual intervention.

Having described LLM/LMM implementations, the discussion now turns to deep learning approaches.

### Training and Deep Learning Models

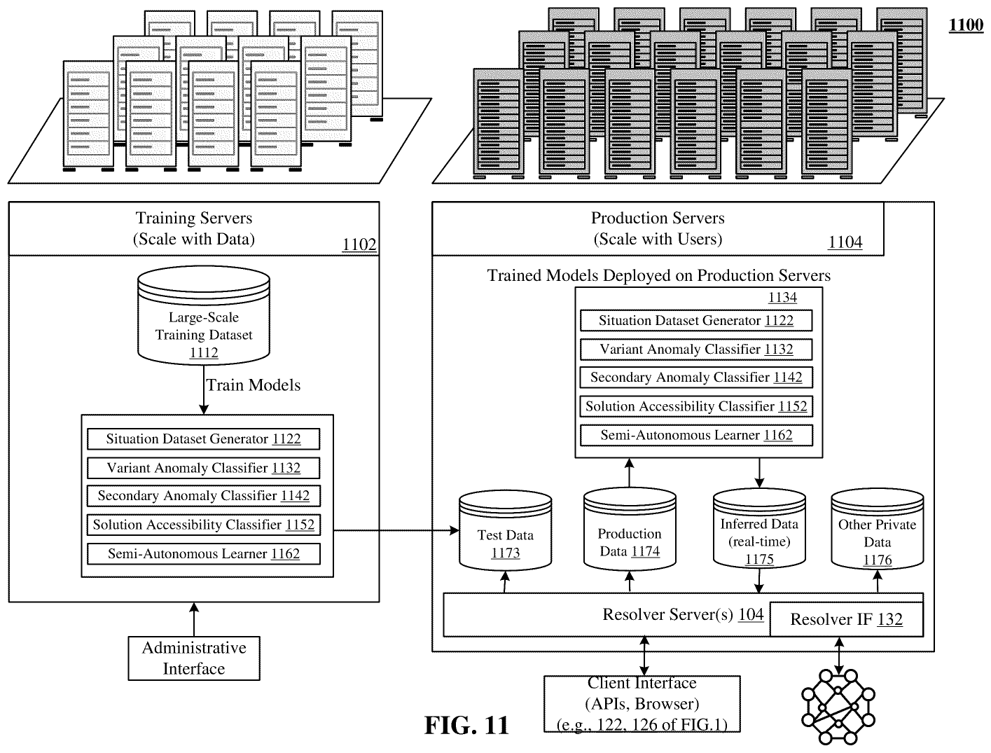

FIG. 11 illustrates a deep learning system in a supervised or semi-supervised implementation. As shown, deep learning system 1100 includes training servers 1102 and production servers 1104. Large scale training dataset 1112 is accessible to training servers 1102 for training the deep convolutional neural network 1134. In an implementation, deep neural network 1134 includes a first anomaly subnetwork, and a second solution accessibility subnetwork that are trained on one or more training servers 1102. The trained deep neural network ensemble including the first trained anomaly subnetwork, and the trained second solution accessibility subnetwork are deployed on one or more production servers 1104 that receive input anomaly information from requesting client devices 122, 126. The production servers 1104 process the input anomaly information through at least one of the deep neural network 1134, the first anomaly subnetwork, and the second solution accessibility subnetwork to produce outputs that are transmitted to the client devices 122, 126.

Training servers 1102 conduct training using models and comprise a situation dataset generator 1122 includes a deep convolutional neural network based variant anomaly classifier, running on numerous processors coupled to memory that prepares training sets comprising data chosen from large scale training dataset 1112 to reflect one or more scenarios being trained, a variant anomaly classifier 1132 includes a deep convolutional neural network based variant anomaly classifier, running on numerous processors coupled to memory that is trained to recognize anomalous situations from sensed data using the scenarios prepared, an optional secondary classifier 1142 includes a deep convolutional neural network based secondary anomaly classifier, running on numerous processors coupled to memory that is trained to recognize special situation anomalies (e.g., radioactive spill, biohazard, etc.), a solution accessibility classifier 1152 includes a deep convolutional neural network based secondary anomaly classifier, running on numerous processors coupled to memory that is trained to recognize anomalies and output identifiers identifying remedial applications that are invoked to trigger remedial actions. A semi-autonomous learner 1162 includes a deep convolutional neural network based variant anomaly classifier, running on numerous processors coupled to memory that progressively augments a set size of the anomaly training set based on the trained ensemble's evaluation of a synthetic set or in implementations, input of live data from a real world scenario.

In one implementation, the neural networks such as situation dataset generator, variant anomaly classifier, secondary anomaly classifier, solution accessibility classifier, and semi-autonomous learner are communicably linked to the storage subsystem comprised of test data database 1173, production data database 1174, inferred data database 1175 and other private data database 1176 and user interface input devices.

In one implementation, data used in one or more of large scale training dataset 1112, test data database 1173, production data database 1174, inferred data database 1175 and other private data database 1176 is selectively obtained from multiple sources of data: (i) various drug databases (e.g., the FDA Product-Specific Guidance database, which enables searching and clustering by active ingredient(s)) and communications including machine reading of emails on recalls minimizes the need to change notification protocols that can be related to machine-readable data and image recognition (e.g. images of pills) and (ii) user responses to deep learning driven follow-up questions selected by the solution accessibility classifier 1152 and semi-autonomous learner 1162 (allowing for live training and refinement).

Other implementations may include a non-transitory computer readable storage medium storing instructions executable by a processor to perform actions of the system described above. Yet another implementation may include a method performing actions of the system described above.

Having described deep learning approaches, the discussion now turns to particular implementations.

### Computer System

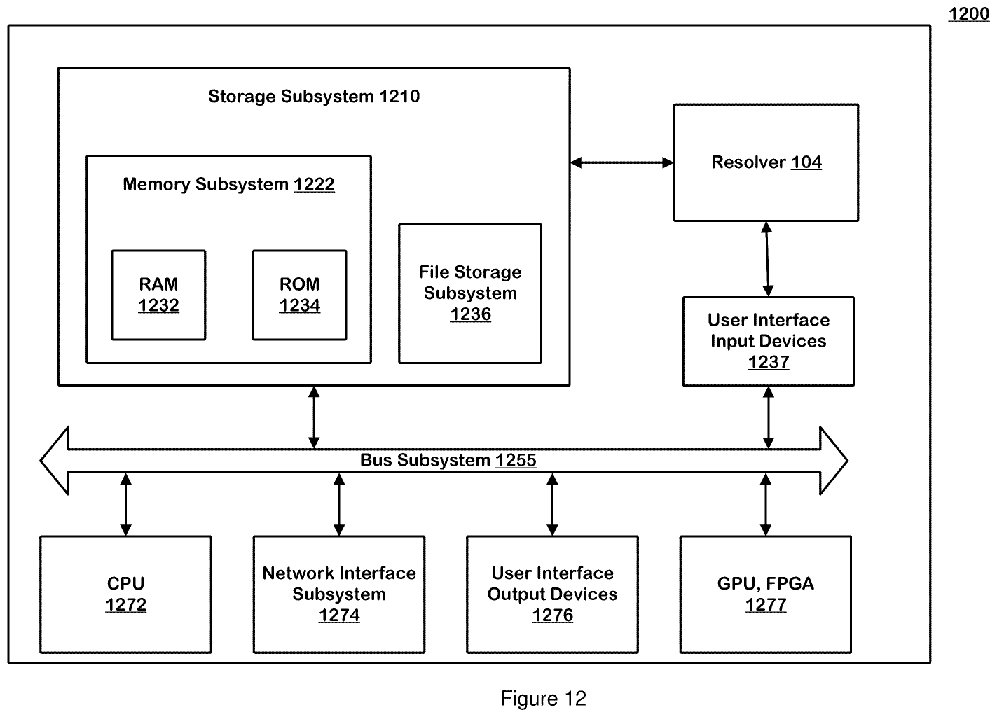

FIG. 12 is a simplified block diagram of a computer system 1200 that can be used for identifying mismatches and other exceptions in data of varying formats being shared across platforms and organizations that provides a resolution of such exceptions identified, within accordance with an implementation of the disclosed technology. Computer system 1200 includes at least one central processing unit (CPU) 1272 that communicates with a number of peripheral devices via bus subsystem 1255 and resolver 104. These peripheral devices can include a storage subsystem 1210 including, for example, memory devices and a file storage subsystem 1236, user interface input devices 1237, user interface output devices 1276, and a network interface subsystem 1274. The input and output devices allow user interaction with computer system 1200. Network interface subsystem 1274 provides an interface to outside networks, including an interface to corresponding interface devices in other computer systems.

In one implementation, resolver 104 of FIG. 1 is communicably linked to the storage subsystem 1210 and the user interface input devices 1237.

User interface input devices 1237 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include a wide variety of possible types of devices and ways to input information into computer system 1200.

User interface output devices 1276 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include many possible types of devices and ways to output information from computer system 1200 to the user or to another machine or computer system.

Storage subsystem 1210 stores programming and data constructs that provide the functionality of some or all of the modules and methods described. Subsystem 1277 can be graphics processing units (GPUs) or field-programmable gate arrays (FPGAs).

Memory subsystem 1222 used in the storage subsystem 1210 can include a number of memories including a main random access memory (RAM) 1232 for storage of instructions and data during program execution and a read only memory (ROM) 1234 in which fixed instructions are stored. A file storage subsystem 1236 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1236 in the storage subsystem 1210, or in other machines accessible by the processor.

Bus subsystem 1255 provides a mechanism for letting the various components and subsystems of computer system 1200 communicate with each other as intended. Although bus subsystem 1255 is shown schematically as a single bus, alternative implementations of the bus subsystem can use multiple busses.

Computer system 1200 itself can be of varying types including a personal computer, a portable computer, a workstation, a computer terminal, a network computer, a television, a mainframe, a server farm, a widely-distributed set of loosely networked computers, or any other data processing system or user device. Due to the everchanging nature of computers and networks, the description of computer system 1200 depicted in FIG. 12 is intended only as a specific example for purposes of illustrating the preferred embodiments of the present invention. Many other configurations of computer system 1200 are possible having more or less components than the computer system depicted in FIG. 12.*

### Some Particular Implementations

We describe various implementations of an Artificial Intelligence (AI) based Resolver for identifying mismatches and other exceptions in data of varying formats being shared across platforms and organizations that provides a resolution of such exceptions identified.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

A system implementation of the technology disclosed includes one or more processors coupled to memory. The memory is loaded with computer instructions for identifying mismatches and other exceptions in data of varying formats being shared across platforms and organizations, which instructions, when executed by one or more processors implement actions comprising: an action of receiving on behalf of a first user device, a document of a second user device. Another action includes processing the document received to establish at least one correspondence between data and data attributes of at least two different fields among a plurality of fields in the document. The method can include a further action comprising applying ensemble Large Language Models (LLMs) or Large Multimodal Models (LMMs) to the data and data attributes of the at least two different fields to obtain missing relationships or data. A yet further action includes generating a notification, in response to detecting a data discrepancy, to a set of contact endpoints of secured channels corresponding with a set of user devices including at least the second user device. The method can yet further include an action of providing, by one or more generative neural networks, a structured format of the document via one or more secured channels to at least the second user device of the set of user devices, thereby enabling at least a user of the second user device to review and confirm the data discrepancy.

This system implementation and other systems disclosed optionally include one or more of the following features. System can also include features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

Each of the features discussed in this particular implementation section for the first system implementation apply equally to this system implementation. As indicated above, all the system features are not repeated here and should be considered repeated by reference.

Other implementations may include a non-transitory computer readable storage medium storing instructions executable by a processor to perform functions of the system described above. Yet another implementation may include a method performing the functions of the system described above.

A method implementation of the technology disclosed includes an action of receiving on behalf of a first user device, a document of a second user device. Another action includes processing the document received to establish at least one correspondence between data and data attributes of at least two different fields among a plurality of fields in the document. The method can include a further action comprising applying ensemble Large Language Models (LLMs) or Large Multimodal Models (LMMs) to the data and data attributes of the at least two different fields to obtain missing relationships or data. A yet further action includes generating a notification, in response to detecting a data discrepancy, to a set of contact endpoints of secured channels corresponding with a set of user devices including at least the second user device. The method can yet further include an action of providing, by one or more generative neural networks, a structured format of the document via one or more secured channels to at least the second user device of the set of user devices, thereby enabling at least a user of the second user device to review and confirm the data discrepancy.

In some embodiments, documents are exchanged between users using secured decentralized channels for authentication and authorization.

Some embodiments further include hashing, signing, or attaching the document in structured format to a verifiable credential or another ledger-based widget. Some embodiments further include forwarding within a same enterprise/entity or outside to a different enterprise/entity, the structured format of the document as a signed digital package using one or more of: via email, specialty rails, DIDComm messaging, legacy rails, AS2.

Some embodiments are further configured to strip out, anonymize, or block transmission of private or otherwise sensitive data.

In some embodiments, the set of user devices encompasses at least 800,000 participating devices.

In some embodiments, structured format of the document includes schemas shared using JavaScript Object Notation (JSON).

In some embodiments, structured data includes a .JSON file containing a file type and one or more unit details.

In some embodiments, unit details include one or more of an item name, an identification number, an expiration date and/or a duration of useful life, and a volume/quantity.

Some embodiments further include scoping at least one LMM to extract data and compare data across documents, substantially without generating de-novo output that is capable of being seen by a third party, thereby mitigating privacy/security risks of the ensemble LMM neural networks being manipulated through prompt-engineering-attacks.

Other implementations may include a non-transitory computer readable storage medium storing instructions executable by a processor to perform functions of the method described above.

Each of the features discussed in this particular implementation section for the first system implementation apply equally to this method implementation. As indicated above, all the system features are not repeated here and should be considered repeated by reference.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Computer readable media (CRM) implementations of the technology disclosed include a non-transitory computer readable storage medium impressed with computer program instructions, when executed on a processor, implement the methods described above.

Each of the features discussed in this particular implementation section for the first system implementation apply equally to the CRM implementation. As indicated above, all the system features are not repeated here and should be considered repeated by reference.

We claim as follows:

1. An Artificial Intelligence (AI) implemented method for identifying mismatches and other exceptions in data of varying formats being shared across platforms and organizations, the method including:
receiving on behalf of a first user device, a document of a second user device;
processing the document received to establish at least one correspondence between data and data attributes of at least two different fields among a plurality of fields in the document;
applying ensemble Large Language Models (LLMs) or Large Multimodal Models (LMMs) to the data and data attributes of the at least two different fields to obtain missing relationships or data;
generating a notification, in response to detecting a data discrepancy, to a set of contact endpoints of secured channels corresponding with a set of user devices including at least the second user device; and
providing, by one or more generative neural networks, a structured format of the document via one or more secured channels to at least the second user device of the set of user devices, thereby enabling at least a user of the second user device to review and confirm the data discrepancy.

2. The method of claim 1, wherein documents are exchanged between users using secured decentralized channels for authentication and authorization.

3. The method of claim 1, further including hashing, signing, or attaching the document in structured format to a verifiable credential or another ledger-based widget.

4. The method of claim 3, further including forwarding within a same enterprise/entity or outside to a different enterprise/entity, the structured format of the document as a signed digital package using one or more of: via email, specialty rails, DIDComm messaging, legacy rails, AS2.

5. The method of claim 1, further configured to strip out, anonymize, or block transmission of private or otherwise sensitive data.

6. The method of claim 1, wherein the set of user devices encompasses at least 800,000 participating devices.

7. The method of claim 1, wherein structured format of the document includes schemas shared using JavaScript Object Notation (JSON).

8. The method of claim 7, wherein structured data includes a .JSON file containing a file type and one or more unit details.

9. The method of claim 8, wherein unit details include one or more of an item name, an identification number, an expiration date and/or a duration of useful life, and a volume/quantity.

10. The method of claim 1, further including scoping at least one LMM to extracting data and comparing data across documents, substantially without generating de-novo output that is capable of being seen by a third party, thereby mitigating privacy/security risks of the ensemble LMM neural networks being manipulated through prompt-engineering-attacks.

11. A non-transitory computer readable medium having stored thereon instructions for identifying mismatches and other exceptions in data of varying formats being shared across platforms and organizations, which instructions, when executed by one or more processors implement actions comprising:
receiving on behalf of a first user device, a document of a second user device;
processing the document received to establish at least one correspondence between data and data attributes of at least two different fields among a plurality of fields in the document;
applying ensemble Large Language Models (LLMs) or Large Multimodal Models (LMMs) to the data and data attributes of the at least two different fields to obtain missing relationships or data;
generating a notification, in response to detecting a data discrepancy, to a set of contact endpoints of secured channels corresponding with a set of user devices including at least the second user device; and
providing, by one or more generative neural networks, a structured format of the document via one or more secured channels to at least the second user device of the set of user devices, thereby enabling at least a user of the second user device to review and confirm the data discrepancy.

12. A system, including one or more hardware processors coupled to a memory, the memory is loaded with computer instructions for identifying mismatches and other exceptions in data of varying formats being shared across platforms and organizations, which instructions, when executed by one or more processors implement actions comprising:
receiving on behalf of a first user device, a document of a second user device;
processing the document received to establish at least one correspondence between data and data attributes of at least two different fields among a plurality of fields in the document;
applying ensemble Large Language Models (LLMs) or Large Multimodal Models (LMMs) to the data and data attributes of the at least two different fields to obtain missing relationships or data;
generating a notification, in response to detecting a data discrepancy, to a set of contact endpoints of secured channels corresponding with a set of user devices including at least the second user device; and
providing, by one or more generative neural networks, a structured format of the document via one or more secured channels to at least the second user device of the set of user devices, thereby enabling at least a user of the second user device to review and confirm the data discrepancy.
